(19) United States
(12) Patent Application Publication
(10) Pub. No.: US 2004/0079924 A1
(43) Pub. Date: Apr. 29, 2004

(54) Blue light-emitting, ladder-type polymer with excellent heat stability

(75) Inventors: Gwang Hoon Kwag, Daejeon (KR); Eun Joo Park, Daejeon (KR); Eun Il Kim, Daejeon (KR); Jae Young Koh, Daejeon (KR)

Correspondence Address: SQUIRE, SANDERS & DEMPSEY L.L.P, 600 HANSEN WAY, PALO ALTO, CA, 94304-1043, US

(73) Assignee: KOREA KUMHO PETROCHEMICAL CO., LTD., Seoul (KR)

(21) Appl. No.: 10/643,144

(22) Filed: Aug. 18, 2003

(30) Foreign Application Priority Data
Oct. 25, 2002 (KR) 10-2002-0065464

(51) Int. Cl. C09K 11/06

(52) U.S. Cl. 252/301.35

(57) ABSTRACT

The invention relates to the ladder-type blue light-emitting polymers with excellent heat stability which are polymerized either grafting with blue luminescent monomers on the polymer backbones or adding fluorene to styrene monomers. The above blue light-emitting polymers have a high glass transition temperature and a 5%-weight-loss temperature above 400° C. Accordingly these polymers can be used as blue luminescent materials in the display devices and as luminescent cases for home appliances or cellular phones.

### FIELD OF THE INVENTION

The present invention relates to the luminescent polymers, specifically the ladder-type blue light-emitting polymers with excellent heat stability, which are prepared by polymerization, after grafting blue luminescent monomers to backbone polymers or after substituting luminescent monomers to styrene derivatives.

### PRIOR ART

Polymers are generally classified as none-conductive and are not used as the electronic materials. Development of conducting polymers such as polyaniline, polypyrrole and polythiophene provided excellent materials with the conductivity same as metals, light weight, and processability.

The conjugated polymers with the electrical and optical characteristics are used as anti-static materials, sensors, electrodes, transistors, light-emitting materials, solar cell, smart cards, electronic newspapers, and other display devices. The luminescence polymer materials have been developed extensively since the electroluminescence with poly(1,4-phenylenevinylene) was reported in Cambridge group in 1990. The materials are, in comparison with the inorganic materials, light weight, thin, self-luminescent, mobile with low voltage, and have fast switching velocity, easy processability, low production cost, low dielectric constant, and prospect of various uses, making them as the light-emitting materials for the information and communication technology of next generation. They provide the advantage of easy fabrication and controllable electrical and optical properties by the modification of their molecular structures.

The blue luminescent polymer uses aromatic compounds such as fluorene or spiro-fluorene as conjugated polymers of the backbone polymers. Examples are described in U.S. Pat. Nos. of 5,593,788, 5,597,890, 5,763,636, and 5,900,327. In U.S. Pat. No. 5.998.045, the luminescent materials are produced by the use of polymers copolymerized by fluorene and anthracene. The copolymers by the fluorene and aromatic compounds (for example, carbazole) are reported in German Patent No.s of 198 46 766, 198 46 767, and 198 46 768. In U.S. Pat. No. 6.395.410, making an electroluminescence device is reported by mixing the luminescent materials and the polymers with low absorption in the visible light regions (such as polycarbonate, polystyrene, polymethacrylate, polyvinylcarbazole). Recently, application research is under way for the organic semiconductor using a thin film (Appl. Phys. Lett. 80(6), 1088).

Much improvements are needed as yet in the durability and brightness of the blue light-emitting polymers when they are applied to the luminescent devices, the main reason being due to their thermal instability. Heat causes molecular movements of polymers and generates fine particles or coagulates the polymers. Generation of heat increases in proportion to the using period of the electroluminescence devices, decreasing their durability when the glass transition temperature and melting temperature are below 300° C. The existing light-emitting polymers have the glass transition temperature at around 100° C. (Macromolecules; 1988; 31(4); 1099-1103) causing the above problems.

### SUMMARY OF THE INVENTION

Therefore, the inventors of the present invention intended to prepare the blue luminescent polymers with high melting point and heat stability.

As the result, as the ladder-type blue light-emitting polymers that can completely satisfy the said problems, the present invention comprises either polymerizing the polymers after grafting the blue light-emitting monomers to their backbone or polymerizing styrene monomers after addition of fluorene group to them.

### BRIEF DESCRIPTION OF THE DRAWINGS

FIG. 1(a) is the conceptual picture of a conventional blue light-emitting polymer.

FIG. 1(b) is the conceptual picture of a ladder-type blue light-emitting polymer.

FIG. 2 shows the Synthetic scheme of the ladder-type blue light-emitting polymer.

FIG. 3 shows the UV-VIS spectrum.

FIG. 4 shows the photoluminescence spectrum.

FIG. 5 shows the TGA of P1.

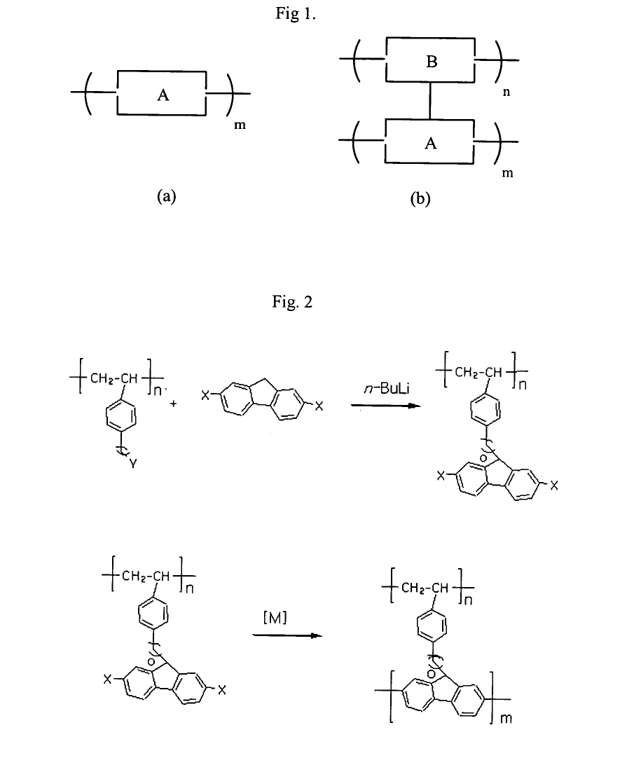

### DETAILED DESCRIPTION OF THE INVENTION

The present invention provides the production of the heat stable, blue light-emitting polymers. Novel luminescent polymers with the ladder-type structure are proposed in order to make highly heat stable polymers differing from the existing luminescent polymers with the glass transition temperature around 100° C. These polymers have high glass transition temperature, above 400° C., and high temperature of 5%-weight loss, above 450° C., and are easily soluble in the organic solvents enabling the production of thin films. The backbone polystyrene is transparent in the visible region, increases compatibility with other polymers, inhibits molecular movement and increases the heat stability.

The conventional polyfluorene and polyaryl polymers have the structure of (a) as shown in the FIG. 1. Their molecular movement at a higher temperature is active, making it difficult to have the glass transition temperature above 100° C. The ladder-type polymers of the invention have a structural composition as shown in (b). In FIG. 1(b), block A is light-emitting part, while block B is polystyrene that has excellent optical properties, heat stability and inhibits molecular movement. The polystyrene block is dissolved in the solvents readily, making it easy to fabricate thin film.

[image]

FIG. 1, The conceptual picture of a conventional blue light-emitting polymer(a) and a ladder-type blue light-emitting polymer(b)

Therefore, the present invention provides the blue light-emitting polymer represented in he FIG. 1(b).

Wherein, A is selected from polyfluorene, polythiophene, polypyrrole, polycarbazole, polyphenylene, polyaniline, polypyridine; B is selected from polystyrene, polypyrrol, polythiophene, polycarbonate, polyphenylene, polyaniline, polypyridine, polycarbazole; n is an integer of 5 to 100; and m is an integer of 2 to 100.

And, the blue light-emitting polymers can be represented by following formula 1.

Wherein A is polyfluorene; B is polystyrene; n is an integer of 5 to 100; and m is an integer of 2 to 100.

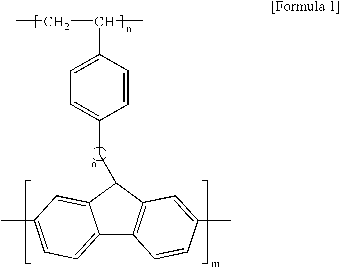

And, the present invention provides the blue light-emitting polymers containing Ar compounds additionally represented in the formula 2

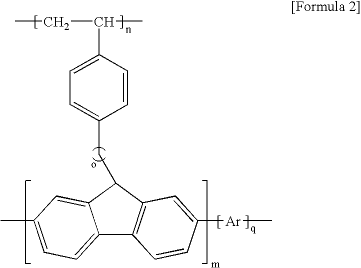

Wherein Ar is aromatic compounds such as fluorene, fluorene derivatives, benzene, benzene derivatives, thiophene, thiophene derivatives, carbazole, carbazole derivatives, pyridine or pyridine derivatives. Preferable, B is the polystyrene with atactic or syndiotactic structure in the formula 1 or 2.

The ladder-type blue light emitting polymers described above can be synthesized in various methods.

The first method comprise eliminating a hydrogen atom from C₉ position of fluorene or dibromofluorene using n-butyl lithium in tetrahydrofuran, grafting polyvinyl benzene chloride to it, and polymerizing aryl groups with the use of nickel or iron catalyst.

The second method comprises substituting chloride atom of vinyl benzene chloride with fluorene, polymerizing the styrene part, and polymerizing fluorene with nickel or iron catalyst. Other method includes polymerizing vinylfluorene, [formula 3], or copolymerizing styrene with vinyllfluorene to make a polymer of [formula 4], and polymerizing the fluorene groups.

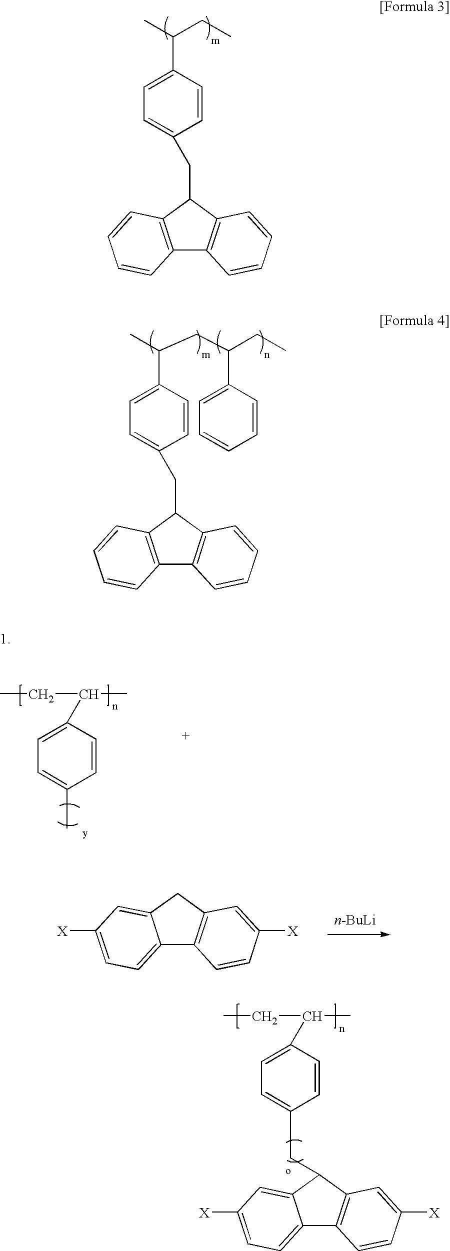

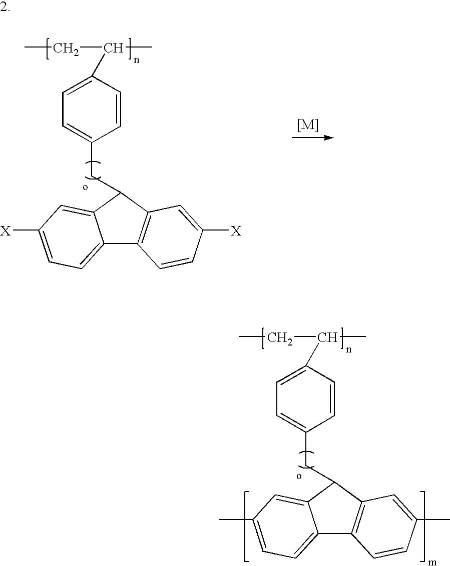

[image]

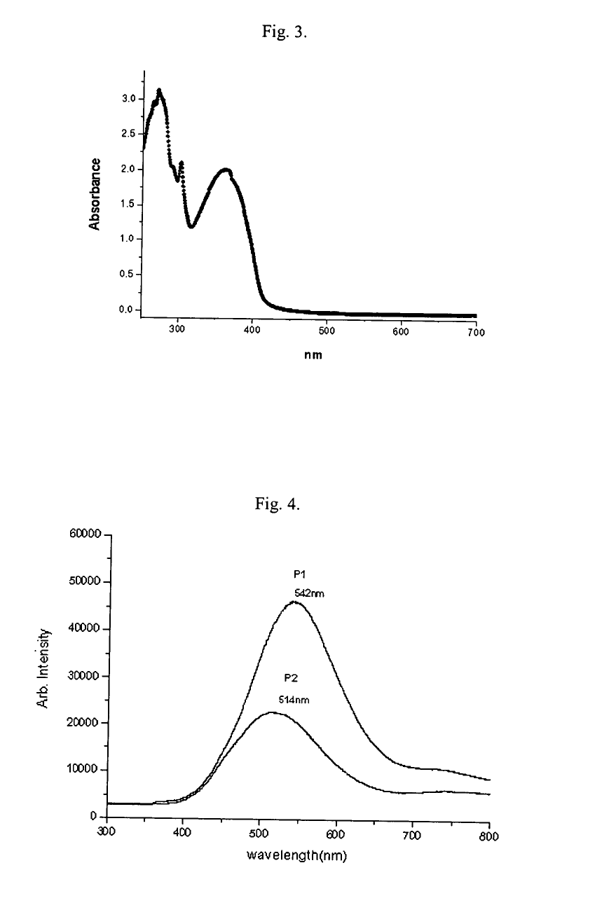

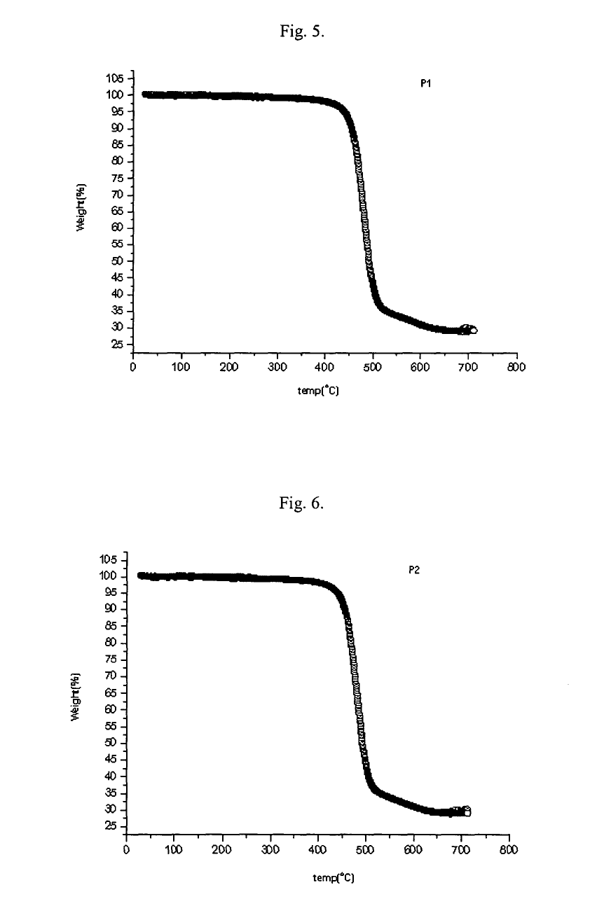

In the UV-Visible spectrum of the polymer P1, λₘₐₓ is obtained at 362 nm (FIG. 3). For P2, λₘₐₓ is also obtained at 362 nm. The emissions of P1 and P2 are in the region of 450-540 nm (FIG. 4). The temperatures of 5%-weight loss of P1 and P2 in TGA are observed at 475° C. and 448° C., respectively (FIGS. 5 & 6). According to DSC, the glass transition temperatures of p1 and P2 are at above 400° C. and the melting points are not observed.

[image]

[image]

[image]

The polymers synthesized, as described above, have phase stability and thus would have a long life while maintaining the efficiency of light emission. In fabricating devices, the polymers can be coated on an electrode by spin-coating or ink-jetting. They can also increase the compatibility with the polymers of good optical properties (for example, polycarbonate, polymethylmethacrylate and polystyrene). The polymers can be copolymerized with aromatic compounds such as fluorene, benzene, thiophene, carbazole, pyridine, styrene and their respective derivatives.

The analytical instruments used are as following. The gel permeation chromatography of Viscotech Co. was used after calibration with polystyrene. The solvent used was tetrahydrofuran (THF). JASCO V-570 for UV-Visible spectrum and Varian Unit Inova 200 (200 MHz) for ¹H-MNR were utilized. TGA was determined by TGC 7/7 of Perkin-Elmer Co. under N₂ atmosphere, increasing the temperature by 20° C./min. Photoluminescence spectra was obtained by Spectrapro 275i & 300i spectrometer of Acton Co. equipped with CCD camera, using W-lamp as a light source.

The following examples further illustrate the present invention in detail but do not limit the scope thereof.

### EXAMPLE 1

### 9-Vinylbenzyl fluorene

Fluorene lithium was prepared by reacting fluorene (10.0 mmol) with t-butyl lithium (1.7M. in pentane, 10.0 mmol) in THF (10 mL) at −78° C. for 2 hours. Fluorene lithium was slowly added to vinyl benzene chloride (10 mmol) in THF solution at −78° C. and reacted with stirring for 16 hours. Water (100 mL) and ether (100 mL) were added and stirred. Organic layer was extracted, dried and recrystalized to obtain needle shape ivory colored solids.

¹H-NMR (200 MHz, CDCl₃): 7.77 (2H, d, Fu-H), 7.39-7.20 (10H, m, Fu-H, Bn-H), 6.80-6.66 (1H, q, Vy-H), 5.80-5.70 (1H, d, Vy-H), 5.27-5.21 (1H, d, Vy-H), 4.23 (1H, t, Fu-H), 3.10 (1H, d, Bz).

### EXAMPLE 2

### Polyvinylbenzyl dibromofluorene

Under N₂ atmosphere, polyvinylbenzyl chloride (1.57 g, M_{w} 55,000) is dissolved in THF (20 mL). Dibromofluorene (3.24 g) was dissolved in THF (50 mL) and cooled to −78° C. To this solution, 4 mL of n-butyl lithium (2.5M, n-hexane solution) was added and the resulting solution was added slwly to the above polyvinyl benzene chloride solution. The mixture was stirred at room temperature for 6 hours and water was added. The product was extracted with ethyl ether (200 mL) and dried under vacuum. Obtained product was yellow solid. M_{w}: 272,900. MWD: 5.71. UV-Vis (λₘₐₓ, THF): 298 nm.

### EXAMPLE 3

### Polyvinylbenzyl fluorene

Under N₂ atmosphere, Polyvinylbenzyl chloride (1.57 g, M_{w} 55,000) was dissolved in THF (20 mL). Fluorene (1.67 g) was dissolved in THF (50 mL) and cooled to −78° C. To this solution added was 4 mL of n-butyl lithium (2.5 M, n-hexane solution). The resultant solution was added to the above polyvinyl benzyl chloride solution. The mixture was stirred for 6 hours at room temperature and water was added. The product was extracted with ethyl ether (200 mL) and dried under vacuum. Yellow solid was obtained.

M_{w}: 68,160. MWD: 2.96. UV-Vis ((λ max, THF): 302 nm.

### EXAMPLE 4

### Polyvinylbenzyl-polyfluorene (P1)

Under N₂ atmosphere, polyvinylbenzyl fluorene (1.57 g, M_{w} 55,000) and dihexylfluorene (3 g) were dissolved in chloroform (20 mL). To the solution FeCl₃ (5 g) was added and stirred for 4 hours at room temperature. To the mixture methanol was added and the produced precipitates were filtered. The obtained solids were dissolved in THF and the insoluble solids were discarded. The THF solution was dried under vacuum and yellow solid was obtained.

M_{w}: 79,040, MWD: 2.94. UV-Vis ((λₘₐₓ, THF): 362 nm. PL (λₘₐₓ, THF): 542 nm. TGA(5%, ° C.): 475, Glass transition temperature(° C.): 421.8.

### EXAMPLE 5

### Polyvinylbenzyl-polyfluorene (P2)

Under N₂ atmosphere, polyvinyl benzyl dibromofluorene (1.57 g, M_{w} 55,000) and dihexylfluorene(3 g) were dissolved in chloroform(20 mL). To the solution FeCl₃ (5 g) was added and stirred for 4 hours at room temperature. To the mixture methanol was added and the produced precipitates were filtered. The obtained solids were dissolved in THF and the insoluble solid was discarded. The THF solution was dried under vacuum and yellow solid was obtained.

M_{w}: 132,200, MWD: 2.07. UV-Vis ((λₘₐₓ, THF): 362 nm. PL (λₘₐₓ, THF): 514 nm. TGA (5%, ° C.): 448, Glass transition temperature (° C.): 404.4.

### EXAMPLE 6

### Polyvinylbenzyl-polyfluorene (P3)

Under N₂ atmosphere, polyvinyl benzyl dibromofluorene (1.57 g, M_{w} 55,000) and dihexylfluorene (3 g) were dissolved in benzene (20 mL). To the solution Pd(PPh₃)₄ (5 g) was added and refluxed for 6 hours. To the mixture, methanol was added and the resultant precipitates were filtered. The obtained solid was dissolved in THF and the insoluble solid was discarded. The THF solution was dried under vacuum and yellow solids were obtained.

M_{w}: 159,300, MWD: 4.34. UV-Vis ((λₘₐₓ, THF): 330 nm. PL (λₘₐₓ, THF): 445 nm.

### EXAMPLE 7

### Polyvinylbenzene-poly(fluorene-co-thiophene) (P4)

Under N₂ atmosphere, polyvinyl benzyl dibromofluorene (500 mg, M_{w} 55,000) and 3-octylthiophene (2 g) were dissolved in chloroform (20 mL). To the solution FeCl₃ (2.5 g) was added and stirred for 4 hours at room temperature. To the mixture methanol was added and the produced precipitates were filtered. The obtained solid was dissolved in THF and the insoluble solid was discarded. The THF solution was dried under vacuum and obtained yellow solid.

M_{w}: 8,911, MWD: 3.14. UV-Vis ((λₘₐₓ, THF): 405 nm. PL (λₘₐₓ, THF): 544, 682 nm. TGA (5%, ° C.): 280, Glass transition temperature(° C.): 384.8

### EXAMPLE 8

### Syndiotactic polyvinylbenzyl fluorene

Under N₂ atmosphere, 1-vinyl-4-(1-fluorenyl)methylbenzene (0.52 g) was added into a flask and dissolved in toluene (20 mL). To the solution, 12.1 mmol of MAO (2.43 mg, 5 mL) was added slowly and stirred for 30 minutes. 10 mmol of CpTiCl₃ (2.19 mg) was dissolved in 1 mL of toluene and added slowly to the solution at room temperature. After addition, the mixture was stirred for one hour at room temperature and poured into a 200 mL of acidic methanol to obtain solid product. The product was washed with methanol and dried under vacuum for several hours and 0.3 g of copolymer was obtained. M_{w}: 2,500.

### EXAMPLE 9

### Syndiotactic polyvinyl benzyl fluorene-co-styrene (P5)

Under N₂ atmosphere, styrene (2.1 g) and 1-vinyl-4-(1-fluorenyl)methylbenzene (0.52 g) was added into the flask and dissolved in toluene (20 mL). To the solution, 12.1 mmol of MAO (2.43 mg, 5 mL) was added slowly and stirred for 30 minutes. 10 mmol of CpTiCl₃ (2.19 mg) was dissolved in 1 mL of toluene and added slowly to the above solution at room temperature. After addition, the mixture was stirred for 2 hours at room temperature and poured into a 200 mL of acidic methanol to obtain solid product. The product was washed with methanol and dried under vacuum for several hours and 2.5 g of copolymer was obtained. M_{w}: 8,000.

### EXAMPLE 10

### Syndiotactic polystyrene-polyfluorene (P6)

Under N₂ atmosphere, P5 (500 mg. M_{w} 8,000) was dissolved in chloroform (20 mL). To the solution, FeCl₃ (2.5 g) was added and stirred for 4 hours at room temperature. Methanol was added to the mixture and the precipitates were filtered. The solid precipitate was dissolved in THF and the insoluble solid was discarded. The THF solution was dried under vacuum and yellow powder was obtained.

M_{w}: 4,802, MWD: 2.42. UV-Vis (λₘₐₓ, THF): 353 nm, PL (λₘₐₓ, THF): 460 nm, TGA (5%, ° C.): 232.8, Glass transition temperature (° C.): 413.5

### Effect of the Invention

As described in details above, the blue light-emitting polymers have a high glass transition temperature and a high temperature of 5% weight-loss. Accordingly, the polymers can be utilized as blue light-emitting materials in the display devices as well as light-emitting cases of household electric appliances and light-emitting cases of cellular phones.

We claim:

1. A ladder-type, blue light-emitting polymers represented by the following formula. 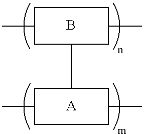
In the formula, A is selected from polyfulorene, polythiophene, polypyrrole, polycarbazole, polyphenylene, polyaniline, polypyridine; B is selected from polystyrene, polypyrrol, polycarbonate, polythiophene, polyphenylene, polyaniline, polypyridine, polycarbazole; n is an integer of 5 to 100; and m is an integer of 2 to 100.

2. The blue light-emitting polymers to claim 1, wherein A is polyfluorene with the following formula and B is polystyrene. 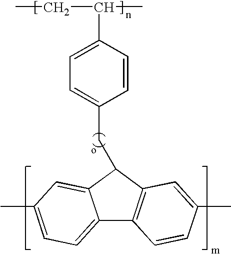
In the formula, n is an integer of 5 to 100; and m is an integer of 2 to 100.

3. The blue light-emitting polymers to claim 2, wherein Ar is aromatic compounds such as fluorene, fluorene derivatives, benzene, benzene derivatives, thiophene, thiophene derivatives, carbazole, carbazole derivatives, pyridine or pyridine derivatives. 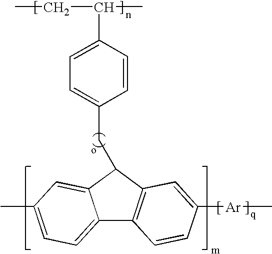
In the formula, n is an integer of 5 to 100; m is an integer of 2 to 100; and q is an integer of 2 to 100.

4. The blue light-emitting polymers to claim 2 or 3, wherein B is the polystyrene specifically with atactic or syndiotactic structure.
